(19) United States
(12) Patent Application Publication
(10) Pub. No.: US 2024/0158642 A1
(43) Pub. Date: May 16, 2024

(54) GRAPHENE-BASED DISPERSION, METHOD(S) AND APPLICATIONS THEREOF

(71) Applicant: RELIANCE INDUSTRIES LIMITED, Mumbai, Maharashtra (IN)

(72) Inventors: Vivek Prabhakar RAJE, Thane (IN); Joseph Berkmans AMIRTHASAMY, Sivaganga (IN); Kaustav GOSWAMI, Kolkata (IN); Debarati Roy CHOWDHURY, Kolkata (IN); Moumita NANDY, Barrackpore (IN)

(73) Assignee: RELIANCE INDUSTRIES LIMITED, Mumbai, Maharashtra (IN)

(21) Appl. No.: 18/281,262

(22) PCT Filed: Mar. 9, 2022
(86) PCT No.: PCT/IB2022/052087

§ 371 Date: Sep. 8, 2023

(30) Foreign Application Priority Data
Mar. 11, 2021 (IN) 202121010367

(51) Int. Cl. C09D 1/00; C01B 32/194; C09D 7/20; C09D 7/45; C09D 7/63; C09D 7/65

(52) U.S. Cl. CPC C09D 1/00; C01B 32/194; C09D 7/20; C09D 7/45; C09D 7/63; C09D 7/65; C01B 2204/02; C01B 2204/04; C01B 2204/28; C01B 2204/32

(57) ABSTRACT

The present disclosure provides a graphene-based dispersion. Said dispersion is characterized by the presence of graphene at a concentration ranging from about 0.0001% (w/w) to about 20% (w/w). The present disclosure further provides a method of preparing the graphene-based dispersion comprising mixing components of the graphene-based dispersion in a high shear mixer. The graphene-based dispersion of the present disclosure is characterized by beneficial features such as but not limited to homogeneity and stability. Further provided in the present disclosure are applications of the graphene-based dispersion.

### TECHNICAL FIELD

The present disclosure generally relates to the field of physicochemistry, material science and solution chemistry. Particularly, the present disclosure relates to graphene and graphene-based dispersions. More particularly, the present disclosure provides a graphene-based dispersion characterized by features of homogeneity and stability.

### BACKGROUND OF THE DISCLOSURE

Graphene is a two-dimensional nanomaterial at its tipping point creating exponential growth in new material development. Structurally it is essentially a honeycomb lattice of sp² hybridized carbon atoms which is single atom thick. This unique two-dimensional structure coupled with a high electron density of the overlapping π-orbitals contributes to exceptional electrical, thermal, mechanical, and optical properties which surpasses the properties of most of the available materials in the world. Together with other emerging technologies such as Artificial Intelligence (AI), Internet of things (IoT), battery, graphene is generating an exponential surge of innovation & new products in a variety of applications such as in water filtration, healthcare, infrastructure, telecommunication, energy storage and so on. Graphene has proven also proven its potential as a multi-dimensional filler in several industries such as petrochemicals, infrastructure, healthcare, paint, adhesive, etc. Further applications of graphene are seen in the health industry, civil engineering, food industry, pharmaceuticals, and in sensitive electronics, such as flexible displays and tyre industry.

The problem faced in the use of graphene is that it is difficult to disperse in solvents such as water-based systems. This could be because the surface of graphene material surface is usually in an inert condition, showing minimal interaction with different media. Said poor dispersiveness of graphene limits its practical applications. Given the high potential graphene presents in terms of the possible applications, there is a need in the art for graphene dispersions that are easy to prepare, homogeneous and can be stably stored for long periods of time.

### SUMMARY OF THE DISCLOSURE

Addressing the aforesaid drawbacks of prior art, the present disclosure provides a graphene-based dispersion comprising graphene at a concentration ranging from about 0.0001% (w/w) to about 20% (w/w); wherein the graphene is a mixture of single layer graphene and few layer graphene.

In some embodiments, the graphene in the graphene-based dispersion comprises about 80% to about 85% single layer graphene and about 15% to about 20% few layer graphene; and wherein the few layer graphene comprises about 2 to about 5 layers of graphene.

In some embodiments, the graphene in the graphene-based dispersion has surface area ranging from about 300 m²/g to about 800 m²/g.

In some embodiments, the graphene-based dispersion comprises surfactant(s); wherein the surfactant(s) is selected from a group comprising polyvinylpyrrolidone (PVP), sodium dodecyl sulfate (SDS), sodium dodecylbenzenesulfate (SDBS), sodium lauryl sulfate (SLS), Sodium lauryl ether sulfate (SLES), sodium cholate, pyrene-carboxylic acid, Silicon, ethoxylated amines, ethoxylated alcohol, alkyl and nonyl-phenol ethoxylates, ethoxylated sorbitan esters, and castor oil ethoxylate, betaines and amine oxides and alkyl ether sulfates, benzyl sulfonates, and phosphate esters or any combination thereof.

In some embodiments, ratio between the graphene and the surfactant(s) in the graphene-based dispersion ranges from about 1:280 to about 2:1, preferably about 1:10 to about 1:2.

In some embodiments, the graphene-based dispersion, optionally, further comprises one or more of wetting agent(s), lubricating agent(s), defoaming agent(s), pH control agent(s), dyeing agent(s) and other standard/conventional agents that enable application of graphene to a surface.

In some embodiments, stability of the graphene-based dispersion ranges from about 1 month to about 2 years.

The present disclosure further provides a method of preparing the graphene-based dispersion as described above, comprising dispersing graphene and/or its derivatives, optionally along with surfactant(s) in a liquid medium and subjecting said dispersion to mixing in a high shear mixer, to obtain the graphene-based dispersion.

Also provided herein is a substrate comprising the graphene-based dispersion of the present disclosure; wherein the substrate is selected from conductive and non-conductive material or a combination thereof.

Further provided in the present disclosure is a method of preparing the above substrate, comprising applying the graphene-based dispersion to the substrate by a method selected from a group comprising dipping, coating, dyeing, brushing, painting, spraying and printing to obtain the substrate comprising the graphene-based dispersion.

### DETAILED DESCRIPTION OF THE DISCLOSURE

In view of the limitations discussed above, and to remedy the need in the art for efficient graphene-based dispersions, the present disclosure aims to provides a graphene-based dispersion characterized by beneficial features such as but not limited to homogeneity and stability.

However, before describing the invention in greater detail, it is important to take note of the common terms and phrases that are employed throughout the present disclosure for better understanding of the technology provided herein.

Throughout the present disclosure, the term ‘graphene’ is intended to convey the ordinary conventional meaning of the term known to a person skilled in the art and intends to cover ‘graphene’ as an allotrope of carbon consisting of a single or multiple layers of carbon atoms. More specifically, ‘graphene’ is a term for a modification of carbon having a two-dimensional structure in which each carbon atom is surrounded by three additional carbon atoms to form a honeycomb pattern. There are various approaches to the preparation of graphene, for example mechanical or chemical exfoliation of graphite or epitaxial growth to silicon carbide or to transition metals. Reference to ‘graphene’ in the present disclosure also envisages employability of ‘graphene derivatives’ in the same context. Thus, any embodiment referring to graphene is meant to be extrapolated to any derivative of graphene as well, unless explicitly stated otherwise.

Throughout the present disclosure, the terms ‘graphene derivatives’, ‘derivatives of graphene’ or the likes are intended to convey the ordinary conventional meaning of the term known to a person skilled in the art and intends to cover structural analogs of graphene, or compounds derived from graphene and having similar characteristics of graphene. In some embodiments of the disclosure, graphene derivatives encompass graphene platelets, graphene nanoplatelets, graphene oxides, reduced graphene oxides, functionalized graphene, doped graphene, graphene decorated with metal particles, nanosized graphene, graphene quantum dots or any graphene containing material.

In embodiments of the disclosure, ‘graphene derivatives’ encompass functionalized graphene. Further, said term ‘functionalized’ or ‘functionalization’ is used interchangeably and is intended to convey the ordinary conventional meaning of the term known to a person skilled in the art in the field of polymer or material science, and intends to cover a process of adding new functions, features, capabilities, or properties to a material by changing the surface chemistry of the material. In the context of graphene employed in the present disclosure, the term is used to cover functionalization of graphene including reactions of graphene (and its derivatives) with organic and/or inorganic molecules, chemical modification of the graphene surface, and the interaction of various covalent and noncovalent components with graphene. The functionalization of graphene is surface modification used to reduce the cohesive force between the graphene sheets and to manipulate the physical and chemical properties of graphene.

In the context of the present disclosure, reference to ‘graphene’ or any ‘derivative of graphene’ envisages graphene or any derivative thereof comprising a combination of single and multi-layer graphene or graphene derivative, preferably single and few layer graphene or graphene derivative, respectively.

‘Few layer graphene’ as used throughout the present disclosure refers to graphene having about 2 to about 5 layers.

In the context of the present disclosure, the terms ‘dispersed’, ‘dispersion’, ‘graphene-based dispersion’, ‘graphene-based dispersion’ or obvious variants thereof refer to a dispersion of graphene wherein the graphene is dispersed throughout the material without substantial aggregation of the graphene. Said ‘graphene-based dispersion’ of the present disclosure may interchangeably be referred to as ‘graphene ink’.

In the context of the present disclosure, ‘high shear mixer’ refers to high shear mixers as commonly known in the art, characterized by features such as high rotor tip speeds, high shear rates and localized energy dissipation rates. Reference to “high shear mixer” envisages high shear reactors (HSRs), rotor-stator mixers, and high shear homogenizers.

Accordingly, the present disclosure provides a dispersion of graphene and/or its derivative(s).

More particularly, the present disclosure provides a graphene-based dispersion comprising graphene and/or its derivative(s) at a concentration ranging from about 0.0001% (w/w) to about 20% (w/w) or ranges derivable therefrom.

In some embodiments, the present disclosure provides a graphene-based dispersion comprising graphene and/or its derivative(s) at a concentration ranging from about 0.0005 wt % to 0.1 wt % (w/w) or ranges derivable therefrom.

In some embodiments, the present disclosure provides a graphene-based dispersion comprising graphene and/or its derivative(s) at a concentration ranging from about 0.5 wt % to 5 wt % (w/w) or ranges derivable therefrom.

In some embodiments, the graphene-based dispersion comprises pure graphene. In some embodiments, the graphene-based dispersion comprises graphene of purity ranging from about 99% to about 99.9999%.

In embodiments of the present disclosure, the graphene or graphene derivative(s) are selected from a group comprising monolayer graphene, bilayer graphene, trilayer graphene, few layer graphene, multi-layer graphene, graphene platelets, graphene nanoplatelets, graphene oxides, reduced graphene oxides, functionalized graphene, doped graphene, graphene decorated with metal particles, nanosized graphene, graphene quantum dots, any graphene containing material, and combinations thereof.

Single layer graphene is the pristine form of graphene having all the attributes in its highest form. However, obtaining 100% pure single layer graphene requires labour intensive processes and thus increases the cost of the production process. Moreover, 100% single layer graphene has extremely high surface area which makes processing difficult. By employing single layer graphene in combination with few layer graphene, these challenges are overcome since few layer graphene has all the required attributes favourable for preparation of a graphene-based dispersion, with surface area that is optimum for processing. Accordingly, in some embodiments, the graphene in the graphene-based dispersion of the present disclosure comprises about 80% to about 85% single layer graphene and about 15% to about 20% few layer graphene. In exemplary embodiments, the graphene comprises about 80% to about 85% single layer graphene and about 15% to about 20% 2-5 layer graphene.

In some embodiments, the graphene in the graphene-based dispersion of the present disclosure comprises about 80%, about 81%, about 82%, about 83%, about 84% or about 85% single layer graphene, and about 15%, about 16%, about 17%, about 18%, about 19% or about 20% few layer graphene. In exemplary embodiments, the graphene comprises about 80% to about 85% single layer graphene and about 15% to about 20% few layer graphene wherein the few layer graphene comprises 2 layer, 3 layer, 4 layer and/or 5 layer graphene.

In some embodiments, the graphene is particularly characterized by surface area ranging from about 300 m²/g to about 800 m²/g. In some embodiments, the graphene has surface area of about 300 m2/g, about 350 m²/g, about 400 m²/g, about 450 m²/g, about 500 m²/g, about 550 m²/g, about 600 m²/g, about 650 m²/g, about 700 m²/g, about 750 m²/g or about 800 m²/g. If the surface area of the graphene drops below the defined range, it may lead to adverse effects on properties of the dispersion. In contrast, if the surface area exceeds the said range and is extremely high then processing becomes challenging.

Surface area is inversely proportional to the number of layers. When the number of layers increase the available surface area decreases and vice versa. The present disclosure achieves a critical balance between the number of layers and the surface area of the employed graphene to obtain a graphene-based dispersion having desired properties.

Accordingly, in preferred embodiments of the present disclosure, the graphene-based dispersion comprises graphene at a concentration ranging from about 0.0001% (w/w) to about 20% (w/w); wherein the graphene is a mixture of single layer graphene and few layer graphene.

In some embodiments, the graphene-based dispersion comprises graphene at a concentration ranging from about 0.0001% (w/w) to about 20% (w/w); wherein the graphene is a mixture of single layer graphene and few layer graphene; and wherein the graphene has a surface area of about 300 m²/g to about 800 m²/g.

In some embodiments, the graphene-based dispersion comprises graphene at a concentration ranging from about 0.0001% (w/w) to about 20% (w/w); wherein the graphene comprises about 80% to about 85% single layer graphene and about 15% to about 20% few layer graphene; and wherein the graphene has a surface area of about 300 m²/g to about 800 m²/g.

In some embodiments, the graphene-based dispersion comprises graphene at a concentration ranging from about 0.0001% (w/w) to about 20% (w/w), wherein the graphene is a mixture of single layer graphene and 2-5 layer graphene; and wherein the graphene has a surface area of about 400 m²/g to 500 m²/g.

In preferred embodiments, the graphene-based dispersion comprises graphene at a concentration ranging from about 0.00010% (w/w) to about 20% (w/w), wherein the graphene comprises about 80% to about 85% single layer graphene and about 15% to about 20% 2-5 layer graphene; and wherein the graphene has a surface area of about 400 m²/g to 500 m²/g.

In further preferred embodiments, the graphene-based dispersion comprises graphene at a concentration ranging from about 0.00010% (w/w) to about 20% (w/w), wherein the graphene comprises about 80% single layer graphene and about 20% 2-5 layer graphene; and wherein the graphene has a surface area of about 400 m²/g to 500 m²/g.

In some embodiments, the graphene-based dispersion is prepared in a liquid medium.

In some embodiments, the graphene-based dispersion comprises the graphene or derivative(s) of graphene dispersed in any liquid medium selected from a group comprising water, organic solvent(s) and inorganic solvent(s) or any combination thereof.

In some embodiments, the water is selected from a group comprising tap water, water from natural source(s), filtered water, milliQ water, distilled water, double distilled water, deionized water or any combination thereof.

In some embodiments, the organic solvent is selected from a group comprising alcohols, hydrocarbons, N-Methyl-2-pyrrolidone (NMP), Dimethylformamide (DMF) or any combination thereof.

In some embodiments, the inorganic solvent is selected from a group comprising water and ionic liquid or a combination thereof.

In some embodiments, the liquid medium is selected from a group comprising water, alcohols, hydrocarbons and combinations thereof.

In exemplary embodiments, the graphene-based dispersion comprises water as the liquid medium.

In a non-limiting embodiment, the graphene or derivative(s) of graphene is present in the dispersion at a concentration of about 0.0001% (w/w), about 0.0002% (w/w), about 0.0003% (w/w), about 0.0004% (w/w), about 0.0005% (w/w), about 0.001% (w/w), about 0.0015% (w/w), about 0.002% (w/w), about 0.0025% (w/w), about 0.003% (w/w), about 0.0035% (w/w), about 0.004% (w/w), about 0.0045% (w/w), about 0.005% (w/w), about 0.0055% (w/w), about 0.006% (w/w), about 0.0065% (w/w), about 0.007%, (w/w), about 0.0075% (w/w), about 0.008% (w/w), about 0.0085% (w/w), about 0.009% (w/w), about 0.0095% (w/w), about 0.01% (w/w), about 0.015% (w/w), about 0.02% (w/w), about 0.025% (w/w), about 0.03% (w/w), about 0.035% (w/w), about 0.04% (w/w), about 0.045% (w/w), about 0.05% (w/w), about 0.055% (w/w), about 0.06% (w/w), about 0.065% (w/w), about 0.07% (w/w), about 0.075% (w/w), about 0.08% (w/w), about 0.085% (w/w), about 0.09% (w/w), about 0.095% (w/w), about 0.1% (w/w), about 0.15% (w/w), about 0.2% (w/w), about 0.25% (w/w about 0.3% (w/w), about 0.35% (w/w), about 0.4% (w/w), about 0.45% (w/w), about 0.5% (w/w), about 0.55% (w/w), about 0.6% (w/w), about 0.65% (w/w), about 0.7% (w/w), about 0.75% (w/w), about 0.8% (w/w), about 0.85% (w/w), about 0.9% (w/w), about 0.95% (w/w), about 1% (w/w), about 1.5% (w/w), about 2% (w/w), about 2.5% (w/w), about 3% (w/w), about 3.5% (w/w), about 4% (w/w), about 4.5% (w/w), about 5% (w/w), about 5.5% (w/w), about 6% (w/w), about 6.5% (w/w), about 7% (w/w), about 7.5% (w/w), about 8% (w/w), about 8.5% (w/w), about 9% (w/w), about 9.5% (w/w), 10% (w/w), about 10.5% (w/w), about 11% (w/w), about 11.5% (w/w), about 12% (w/w), about 12.5% (w/w), about 13% (w/w), about 13.5% (w/w), about 14% (w/w), about 14.5% (w/w), about 15% (w/w), about 15.5% (w/w), about 16% (w/w), about 16.5% (w/w), about 17% (w/w), about 17.5% (w/w), about 18% (w/w), about 18.5% (w/w), about 19% (w/w), about 19.5% (w/w), or about 20% (w/w).

In some embodiments, the graphene-based dispersion optionally comprises surfactant(s).

Accordingly, in some embodiments, provided herein is a graphene-based dispersion comprising graphene and/or its derivative(s) at a concentration ranging from about 0.0001% (w/w) to about 20% (w/w) along with surfactant(s).

In some embodiments, the graphene-based dispersion comprises graphene at a concentration ranging from about 0.0001% (w/w) to about 20% (w/w) along with surfactant(s), wherein the graphene is a mixture of single layer graphene and few layer graphene.

In some embodiments, the graphene-based dispersion comprises graphene at a concentration ranging from about 0.0001% (w/w) to about 20% (w/w) along with surfactant(s), wherein the graphene is a mixture of single layer graphene and few layer graphene; and wherein the graphene has a surface area of about 300 m²/g to about 800 m²/g.

In some embodiments, the graphene-based dispersion comprises graphene at a concentration ranging from about 0.0001% (w/w) to about 20% (w/w) along with surfactant(s), wherein the graphene is a mixture of single layer graphene and 2-5 layer graphene; and wherein the graphene has a surface area of about 400 m²/g to about 500 m²/g.

In preferred embodiments, the graphene-based dispersion comprises graphene at a concentration ranging from about 0.0001% (w/w) to about 20% (w/w) along with surfactant(s); wherein the graphene comprises about 80% to about 85% of single layer graphene and about 15% to about 20% of 2-5 layer graphene; and wherein the graphene has a surface area of about 400 m²/g to about 500 m²/g.

In further preferred embodiments, the graphene-based dispersion comprises graphene at a concentration ranging from about 0.0001% (w/w) to about 20% (w/w) along with surfactant(s); wherein the graphene comprises about 80% single layer graphene and about 20% of 2-5 layer graphene; and wherein the graphene has a surface area of about 400 m²/g to about 500 m²/g.

In some embodiments the surfactant(s) is selected from a group comprising non-ionic surfactant, amphoteric surfactant, cationic surfactant and anionic surfactant or any combination thereof.

In exemplary embodiments the surfactant(s) is a combination of non-ionic surfactant and amphoteric surfactant. In a non-limiting embodiment, said combination of surfactants is particularly helpful in improving the shelf life of the dispersion.

In some embodiments, the surfactant(s) is selected from a group comprising polyvinylpyrrolidone (PVP), sodium dodecyl sulfate (SDS), sodium dodecylbenzenesulfate (SDBS), sodium lauryl sulfate (SLS), Sodium lauryl ether sulfate (SLES), sodium cholate, Pyrene-carboxylic acid, Silicon, ethoxylated amines, ethoxylated alcohol, alkyl and nonyl-phenol ethoxylates, ethoxylated sorbitan esters, and castor oil ethoxylate, Betaines and amine oxides and alkyl ether sulfates, benzyl sulfonates, and phosphate esters or any combination thereof.

In some embodiments, the surfactant(s) is a combination of at least 2 surfactants selected from a group comprising polyvinylpyrrolidone (PVP), sodium dodecyl sulfate (SDS), sodium dodecylbenzenesulfate (SDBS), sodium lauryl sulfate (SLS), Sodium lauryl ether sulfate (SLES), sodium cholate, Pyrene-carboxylic acid, Silicon, ethoxylated amines, ethoxylated alcohol, alkyl and nonyl-phenol ethoxylates, ethoxylated sorbitan esters, and castor oil ethoxylate, Betaines and amine oxides and alkyl ether sulfates, benzyl sulfonates, and phosphate esters or any combination thereof.

In some embodiments, the ratio between the graphene and the surfactant(s) in the graphene-based dispersion ranges from about 1:280 to about 2:1, including all values or ranges derivable therefrom.

In an exemplary embodiment, the ratio between the graphene and the surfactant(s) in the graphene-based dispersion ranges from about 1:10 to about 1:2.

Accordingly, in some embodiments, provided herein is a graphene-based dispersion comprising graphene at a concentration ranging from about 0.0001% (w/w) to about 20% (w/w) along with surfactant(s); wherein the graphene is a mixture of single layer graphene and few layer graphene; and wherein ratio between the graphene and the surfactant(s) in the graphene-based dispersion ranges from about 1:10 to about 1:2.

In some embodiments, provided herein is a graphene-based dispersion comprising graphene at a concentration ranging from about 0.0001% (w/w) to about 20% (w/w) along with surfactant(s); wherein the graphene comprises about 80% to about 85% of single layer graphene and about 15% to about 20% of 2-5 layer graphene; wherein the graphene has a surface area of about 400 m²/g to about 500 m²/g; and wherein ratio between the graphene and the surfactant(s) in the graphene-based dispersion ranges from about 1:10 to about 1:2.

In some embodiments, the graphene-based dispersion further comprises one or more of wetting agent(s), lubricating agent(s), defoaming agent(s), pH control agent(s), and other standard/conventional agents that enable application of graphene to a surface.

Accordingly, in some embodiments, provided herein is a graphene-based dispersion comprising graphene at a concentration ranging from about 0.0001% (w/w) to about 20% (w/w) along with surfactant(s); wherein the graphene is a mixture of single layer graphene and few layer graphene; and wherein the graphene-based dispersion optionally comprises agents selected from a group comprising wetting agent(s), lubricating agent(s), defoaming agent(s), pH control agent(s), and other standard/conventional agents that enable application of graphene to a surface or any combination thereof.

In some embodiments, provided herein is a graphene-based dispersion comprising graphene at a concentration ranging from about 0.0001% (w/w) to about 20% (w/w) along with surfactant(s); wherein the graphene comprises about 80% to about 85% of single layer graphene and about 15% to about 20% of 2-5 layer graphene; wherein the graphene has a surface area of about 400 m²/g to about 500 m²/g; wherein ratio between the graphene and the surfactant(s) in the graphene-based dispersion ranges from about 1:10 to about 1:2; and wherein the graphene-based dispersion optionally comprises agents selected from a group comprising wetting agent(s), lubricating agent(s), defoaming agent(s), pH control agent(s), and other standard/conventional agents that enable application of graphene to a surface or any combination thereof.

In some embodiments, the wetting agent is selected from the group comprising cationic agent, anionic agent, non-ionic agent, amphoteric agent and combinations thereof.

In some embodiments, when present in the graphene-based dispersion, the wetting agent is in an amount of about 0.1% to about 1% (w/w), including all values or ranges derivable therefrom.

In a non-limiting embodiment, the wetting agent is present in the graphene-based dispersion at a concentration of about 0.1 wt %, about 0.2 wt %, about 0.3 wt %, about 0.4 wt %, about 0.5 wt %, about 0.6 wt %, about 0.7 wt %, about 0.8 wt %, about 0.9 wt % or about 1 wt %.

In some embodiments, the lubricating agent is selected from the group comprising polyglycol ethers, silicone-based lubricant, mineral oil-based lubricant, other non-ionic lubricants and combinations thereof.

In some embodiments, when present in the graphene-based dispersion, the lubricating agent is in an amount of about 0.01% to about 1% (w/w), including all values or ranges derivable therefrom.

In a non-limiting embodiment, the lubricating agent is present in the graphene-based dispersion at a concentration of about 0.01 wt %, about 0.1 wt %, about 0.2 wt %, about 0.3 wt %, about 0.4 wt %, about 0.5 wt %, about 0.6 wt %, about 0.7 wt %, about 0.8 wt %, about 0.9 wt % or about 1 wt %.

In some embodiments, the defoaming agent is selected from the group comprising polyether, silicone polyether, and a combination thereof.

In some embodiments, when present in the graphene-based dispersion, the defoaming agent is in an amount of about 0.1% to about 2% (w/w), including all values or ranges derivable therefrom.

In a non-limiting embodiment, the defoaming agent is present in the graphene-based dispersion at a concentration of about 0.1 wt %, about 0.2 wt %, about 0.3 wt %, about 0.4 wt %, about 0.5 wt %, about 0.6 wt %, about 0.7 wt %, about 0.8 wt %, about 0.9 wt %, about 1 wt %, 1.1 wt %, about 1.2 wt %, about 1.3 wt %, about 1.4 wt %, about 1.5 wt %, about 1.6 wt %, about 1.7 wt %, about 1.8 wt %, about 1.9 wt % or about 2 wt %.

In some embodiments, the pH control agent is selected from the group comprising Auxigreen acid, citric acid, acetic acid and combinations thereof.

In some embodiments, when present in the graphene-based dispersion, the pH control agent is in an amount of about 0.1% to about 1% (w/w), including all values or ranges derivable therefrom.

In a non-limiting embodiment, the pH control agent is present in the graphene-based dispersion at a concentration of about 0.1 wt %, about 0.2 wt %, about 0.3 wt %, about 0.4 wt %, about 0.5 wt %, about 0.6 wt %, about 0.7 wt %, about 0.8 wt %, about 0.9 wt % or about 1 wt %.

In some embodiments, the graphene-based dispersion is a homogeneous and stable dispersion.

Said graphene-based dispersion of the present dispersion further has a long shelf life. In some embodiments, the graphene-based dispersion has a shelf life of about 1 month to 2 years.

In some embodiments, the graphene-based dispersion has viscosity ranging from about 1 cp to about 100000 cp, including all values or ranges derivable therefrom.

In some embodiments, the graphene-based dispersion of the present disclosure is referred to as ‘graphene ink’.

The present disclosure further provides a method for preparing the graphene-based dispersion described above.

In some embodiments of the present disclosure, the method for preparing the graphene-based dispersion comprises dispersing graphene and/or its derivatives in a liquid medium.

In some embodiments, the graphene-based dispersion is prepared by dispersing graphene and/or its derivatives optionally along with surfactant(s) in a liquid medium.

In an exemplary embodiment of the present disclosure, the method for preparing the graphene-based dispersion comprises dispersing graphene and/or its derivatives in a liquid medium and subjecting said dispersion to mixing in a high shear mixer, to obtain the graphene-based dispersion.

In some embodiments, the act/step of dispersing graphene and/or its derivatives in a liquid medium before mixing is performed inside or outside the high shear mixer.

In some embodiments of the present disclosure, the method for preparing the graphene-based dispersion comprises dispersing graphene and/or its derivatives optionally along with surfactant(s) in a liquid medium and subjecting the dispersion to mixing in a high shear mixer, to obtain the graphene-based dispersion.

In some embodiments of the present disclosure, the method for preparing the graphene-based dispersion comprises dispersing graphene and/or its derivatives optionally along with one or more of surfactant(s), wetting agent(s), lubricating agent(s), defoaming agent(s) and pH control agent(s) in a liquid medium and subjecting the dispersion to mixing in a high shear mixer, to obtain the graphene-based dispersion.

In some embodiments, the speed of mixing the dispersion in the high shear mixer ranges from about 100 rpm to about 10000 rpm.

In exemplary embodiments, the speed of mixing the dispersion in the high shear mixer ranges from about 2000 rpm to about 10000 rpm.

In some embodiments, the mixing of the dispersion in the high shear mixer is performed for about 1 minute to about 600 minutes.

In some embodiments, the time for mixing depends on the batch size.

In some embodiments, the mixing in the high shear mixer is performed for about 1 hour to about 6 hours.

While there is no restriction on the order of mixing of the components forming the graphene-based dispersion in the above described method, in some embodiments, the method for preparing the graphene-based dispersion comprises
mixing the surfactant in the liquid medium;
adding the graphene and/or its derivatives to the mixture of the surfactant and the liquid medium; and
subjecting the dispersion to mixing in a high shear mixer,
to obtain the graphene-based dispersion.

In some embodiments, the mixing of the surfactant in the liquid medium is achieved by adding the surfactant to the liquid medium and subjecting the mixture to high shear mixing at a speed of about 100 rpm to about 10000 rpm for about 10 minutes to about 30 minutes.

In some embodiments, the additional agents, which may optionally be incorporated in the graphene-based dispersion of the present disclosure, such as wetting agent(s), lubricating agent(s), defoaming agent(s) and pH control agent(s) or any combination thereof, may be added to the dispersion at any stage during the mixing of components to obtain the desired dispersion. In some embodiments, said additional agents, are added into the liquid medium along with, before or after the surfactant. In some embodiments, said additional agents, are added into the surfactant containing liquid medium along with, before or after addition of the graphene. In some embodiments, the additional agents are added into the dispersion containing the graphene and surfactant dispersed in the liquid medium and subjected to further mixing.

The present disclosure further relates to a graphene-based dispersion obtained by the aforesaid method(s).

Accordingly, provided herein is a graphene-based dispersion obtained by dispersing graphene and/or its derivatives optionally along with surfactant(s) in a liquid medium and subjecting the dispersion to mixing in a high shear mixer.

In some embodiments, provided herein is a graphene-based dispersion obtained by dispersing graphene and/or its derivatives optionally along with one or more of surfactant(s), wetting agent(s), lubricating agent(s), defoaming agent(s), pH control agent(s) and dyeing agent(s) in a liquid medium and subjecting the dispersion to mixing in a high shear mixer.

Said graphene-based dispersion of the present disclosure is particularly characterized by stability of the dispersion for about 1 month to about 2 years.

The present disclosure further provides use of the graphene-based dispersion for various applications.

In non-limiting embodiments, the graphene-based dispersion can be used in a variety of applications where properties such as but not limited to mechanical strength, antimicrobial property, thermal conductivity, electrical conductivity, UV blocking property and gas barrier property are pre-requisites.

In some embodiments, concentration of graphene in the graphene-based dispersion and the amount of the graphene-based dispersion used may vary as per the nature of the intended application.

In some embodiments, the graphene-based dispersion is used for application to a substrate. In some embodiments, application of the graphene-based dispersion to the substrate confers to the substrate properties such as but not limited to mechanical strength, antimicrobial property, thermal conductivity, electrical conductivity, UV blocking property and gas barrier property.

In some embodiments, the graphene-based dispersion is used in the preparation of graphene coated or infused fibres and/or fabric that may further be used to manufacture aprons, garments, furniture covers, bed covers, pillow covers, curtains, other apparels, upholstery, carpets and bags. Said applications require incorporation of graphene is incorporated at lower concentrations and confer to the fibres and/or fabric properties such as but not limited to mechanical strength, antimicrobial, thermal conductivity, electrical conductivity, UV blocking and gas barrier.

In some embodiments, application of the graphene-based dispersion to the substrate confers to the substrate sensing properties such as but not limited to sensing of gases, sweat and mechanical vibrations such as heart beats.

Accordingly, in some embodiments, the graphene-based dispersion is used in the preparation of graphene coated or infused surfaces in articles such as but not limited to fabric, fibres or devices for smart wear applications.

Further provided herein, is the graphene-based dispersion(s) of the present disclosure for use in any of the aforesaid applications.

Further, envisaged herein is a substrate comprising the graphene-based dispersion of the present disclosure.

In some embodiments, the substrate is selected from conductive and non-conductive material.

In some embodiments, the substrate is selected from but not limited to metal, glass, plastic, wood, rubber, paper, fibres and fabric.

The present disclosure further relates to a method of preparing the aforesaid substrate comprising the graphene-based dispersion of the present disclosure wherein said method comprises applying the graphene-based dispersion to the substrate by a method such as but not limited to dipping, coating, dyeing, brushing, painting, spraying and printing to obtain the substrate comprising the graphene-based dispersion.

While the instant disclosure is susceptible to various modifications and alternative forms, specific aspects thereof have been shown by way of examples and are described in detail below. However, it should be understood that it is not intended to limit the invention to the particular forms disclosed, but on the contrary, the intention is to cover all modifications, equivalents, and alternatives falling within the spirit and the scope of the invention as defined by the appended claims.

### EXAMPLES

The present disclosure is further described with reference to the following examples, which are only illustrative in nature and should not be construed to limit the scope of the present disclosure in any manner.

### Example 1: Preparing a Graphene-Based Dispersion with Polyvinyl Pyrrolidone (PVP) as Surfactant

About 0.2 kg PVP was dispersed in about 48.8 kg water and mixed using a high shear mixer at about 6500 rpm for about 15 minutes. A water-based graphene dispersion was prepared by dispersing about 85% of single layer graphene and about 15% of few layer graphene (2-3 layers) having surface area of about 400-500 m²/g in the PVP containing water and mixing for about 3 hours at about 6500 rpm to obtain a homogenous dispersion of graphene. The ratio of concentration of surfactant:graphene was maintained at about 1:5. The final concentration of graphene in dispersion was about 2 wt %.

The prepared graphene slurry was found to be stable for about 6 months.

### Example 2: Preparing a Graphene-Based Dispersion with Polyvinyl Pyrrolidone (PVP) as Surfactant

About 1 kg PVP was dispersed in about 47 kg water and mixed using a high shear mixer at about 6500 rpm for about 15 minutes. A water-based graphene dispersion was prepared by dispersing about 80% of single layer graphene and about 20% of few layer graphene (2-3 layers) having surface area of about 400-500 m²/g in the PVP containing water and mixing for about 3 hours at about 6500 rpm to obtain a homogenous dispersion of graphene. The ratio of concentration of surfactant:graphene was maintained at about 1:2. The final concentration of graphene in dispersion was about 4 wt %.

The prepared graphene slurry was found to be stable for about 6 months.

### Example 3: Preparing a Graphene-Based Dispersion with Sodium Dodecyl Sulfate (SDS) as Surfactant

About 0.5 kg SDS was dispersed in about 48.5 kg water and mixed using a high shear mixer at about 8000 rpm for about 15 minutes. A water-based graphene dispersion was prepared by dispersing about 85% of single layer graphene and about 15% of few layer graphene (2-3 layers) having surface area of about 400-500 m²/g in the SDS containing water and mixing for about 4 hours at about 8000 rpm to obtain a homogenous dispersion of graphene. The ratio of concentration of surfactant:graphene was maintained at about 1:2. The final concentration of graphene in dispersion was about 2 wt %.

The prepared graphene slurry was found to be stable for about 1 month.

### Example 4: Comparison of Stability of Different Dispersions

Following the same procedure as the above examples, the dispersions comprising the components as shown in the below table were prepared—

TABLE 1

| | Graphene quantity | | | | |
|---|---|---|---|---|---|
| | (single layer + | | | | Dispersion |
| Dispersion | few layer) | | | | Stability |
| No. | (Kg) | Surfactant 1 | Surfactant 2 | Water | (Months) |
| 1. | 1 | Polyvinyl pyrrolidone | NIL | 48.6 | 6 |
| | | (PVP) | | | |
| | | 0.4 | | | |
| 2. | 1 | Sodium | NIL | 48.6 | 1 |
| | | dodecylsulfate (SDS) | | | |
| | | 0.4 | | | |
| 3. | 1 | Sodium | NIL | 48.6 | 1 |
| | | dodecylbenzenesulfate | | | |
| | | (SDBS) | | | |
| | | 0.4 | | | |
| 4. | 1 | Sodium cholate | NIL | 48.6 | 2 |
| | | 0.4 | | | |
| 5. | 1 | Sodium cholate | Polyvinyl | 48.2 | 6 |
| | | 0.4 | pyrrolidone | | |
| | | | (PVP) | | |
| | | | 0.4 | | |
| 6. | 1 | Sodium | Sodium | 48.2 | 6 |
| | | dodecylbenzenesulfate | cholate | | |
| | | (SDBS) | 0.4 | | |
| | | 0.4 | | | |
| 7. | 1 | Sodium cholate | Polyvinyl | 47.6 | 10 |
| | | 0.4 | pyrrolidone | | |
| | | | (PVP) | | |
| | | | 1 | | |
| 8. | 1 | Sodium cholate | Polyvinyl | 47.6 | 8 |
| | | 0.4 | pyrrolidone | | |
| | | | (PVP) | | |
| | | | 0.4 | | |
| 9. | 1 | Pyrene-carboxylic | | 48.6 | 4 |
| | | acid | | | |
| | | 0.4 | | | |
| 10. | 1 | Sodium | Sodium | 48.2 | 4 |
| | | dodecylbenzenesulfate | cholate | | |
| | | (SDBS) | 0.4 | | |
| | | 0.4 | | | |
| 11. | 1 | Cetyltrimethyl | | 48.6 | 1 |
| | | ammonium bromide | | | |
| | | (CTAB) | | | |
| | | 0.4 | | | |

As seen from the above examples, the graphene-based dispersion of the present disclosure provides a minimum stability of about 1 month.

Additional embodiments and features of the present disclosure will be apparent to one of ordinary skill in art based on the description provided herein. The embodiments herein provide various features and advantageous details thereof in the description. Descriptions of well-known/conventional methods and techniques are omitted so as to not unnecessarily obscure the embodiments herein.

The foregoing description of the specific embodiments fully reveals the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments in this disclosure have been described in terms of preferred embodiments, those skilled in the art will recognize that the embodiments herein can be practiced with modification within the spirit and scope of the embodiments as described herein.

With respect to the use of substantially any plural and/or singular terms herein, those having skill in the art can translate from the plural to the singular and/or from the singular to the plural as is appropriate to the context and/or application. Various singular/plural permutations may be expressly set forth herein for sake of clarity. The use of the expression ‘at least’ or ‘at least one’ suggests the use of one or more elements or ingredients or quantities, as the use may be in the embodiment of the disclosure to achieve one or more of the desired objects or results. Numerical ranges stated in the form ‘from x to y’ include the values mentioned and those values that lie within the range of the respective measurement accuracy as known to the skilled person. If several preferred numerical ranges are stated in this form, of course, all the ranges formed by a combination of the different end points are also included.

The terms “about” or “approximately” as used in the present disclosure when referring to a measurable value such as a parameter, an amount, a temporal duration, and the like, are meant to encompass variations of and from the specified value, such as variations of +/−10% or less, +/−5% or less, +/−1% or less, and +/−0.1% or less of and from the specified value, insofar such variations are appropriate to perform in the disclosed invention. It is to be understood that the value to which the modifier “about” or “approximately” refers is itself also specifically, and preferably, disclosed.

As used in the present disclosure, the terms “include” (any form of “include”, such as “include”), “have” (and “have”), “comprise” etc. any form of “having”, “including” (and any form of “including” such as “including”), “containing”, “comprising” or “comprises” are inclusive and will be understood to imply the inclusion of a stated element, integer or step, or group of elements, integers or steps, but not the exclusion of any other element, integer or step, or group of elements, integers or steps It is to be noted that the term “a” or “an” entity refers to one or more of that entity. As such, the terms “a” (or “an”), “one or more”, and “at least one” can be used interchangeably herein.

As regards the embodiments characterized in this specification, it is intended that each embodiment be read independently as well as in combination with another embodiment. For example, in case of an embodiment 1 reciting 3 alternatives A, B and C, an embodiment 2 reciting 3 alternatives D, E and F and an embodiment 3 reciting 3 alternatives G, H and I, it is to be understood that the specification unambiguously discloses embodiments corresponding to combinations A, D, G; A, D, H; A, D, I; A, E, G; A, E, H; A, E, I; A, F, G; A, F, H; A, F, I; B, D, G; B, D, H; B, D, I; B, E, G; B, E, H; B, E, I; B, F, G; B, F, H; B, F, I; C, D, G; C, D, H; C, D, I; C, E, G; C, E, H; C, E, I; C, F, G; C, F, H; C, F, I, unless specifically mentioned otherwise.

Any discussion of documents, acts, materials, devices, articles and the like that has been included in this specification is solely for the purpose of providing a context for the disclosure. It is not to be taken as an admission that any or all of these matters form a part of the prior art base or were common general knowledge in the field relevant to the disclosure as it existed anywhere before the priority date of this application.

While considerable emphasis has been placed herein on the particular features of this disclosure, it will be appreciated that various modifications can be made, and that many changes can be made in the preferred embodiments without departing from the principles of the disclosure. These and other modifications in the nature of the disclosure or the preferred embodiments will be apparent to those skilled in the art from the disclosure herein, whereby it is to be distinctly understood that the foregoing descriptive matter is to be interpreted merely as illustrative of the disclosure and not as a limitation.

We claim:

1. A graphene-based dispersion comprising graphene at a concentration ranging from about 0.0001% (w/w) to about 20% (w/w); wherein the graphene is a mixture of single layer graphene and few layer graphene.

2. The graphene-based dispersion as claimed in claim 1, wherein the graphene comprises about 80% to about 85% single layer graphene and about 15% to about 20% few layer graphene; and wherein the few layer graphene comprises about 2 to about 5 layers of graphene.

3. The graphene-based dispersion as claimed in claim 1, wherein the graphene has surface area ranging from about 300 m²/g to about 800 m²/g, preferably about 400 m²/g to about 500 m²/g.

4. The graphene-based dispersion as claimed in claim 1, wherein the graphene-based dispersion is prepared in any liquid medium selected from a group comprising water, organic solvent(s) and inorganic solvent(s) or any combination thereof.

5. The graphene-based dispersion as claimed in claim 4, wherein the water is selected from a group comprising tap water, water from natural source(s), filtered water, milliQ water, distilled water, double distilled water, deionized water or any combination thereof, wherein the organic solvent is selected from a group comprising alcohols, hydrocarbons, N-Methyl-2-pyrrolidone (NMP), Dimethylformamide (DMF) or any combination thereof, and wherein the inorganic solvent is selected from a group comprising water and ionic liquid or a combination thereof.

6. The graphene-based dispersion as claimed in claim 1, wherein the graphene-based dispersion comprises surfactant(s); wherein the surfactant(s) is selected from a group comprising polyvinylpyrrolidone (PVP), sodium dodecyl sulfate (SDS), sodium dodecylbenzenesulfate (SDBS), sodium lauryl sulfate (SLS), Sodium lauryl ether sulfate (SLES), sodium cholate, pyrene-carboxylic acid, Silicon, ethoxylated amines, ethoxylated alcohol, alkyl and nonyl-phenol ethoxylates, ethoxylated sorbitan esters, and castor oil ethoxylate, betaines and amine oxides and alkyl ether sulfates, benzyl sulfonates, and phosphate esters or any combination thereof.

7. The graphene-based dispersion as claimed in claim 6, wherein ratio between the graphene and the surfactant(s) in the graphene-based dispersion ranges from about 1:280 to about 2:1, preferably about 1:10 to about 1:2.

8. The graphene-based dispersion as claimed in claim 1, wherein the graphene-based dispersion comprises one or more of wetting agent(s), lubricating agent(s), defoaming agent(s), pH control agent(s), dyeing agent(s) and other standard/conventional agents that enable application of graphene to a surface.

9. The graphene-based dispersion as claimed in claim 1, wherein the wetting agent is selected from the group comprising cationic agent, anionic agent, non-ionic agent, amphoteric agent and combinations thereof, wherein the lubricating agent is selected from the group comprising polyglycol ethers, silicone-based lubricant, mineral oil-based lubricant, other non-ionic lubricants and combinations thereof, wherein the defoaming agent is selected from the group comprising polyether, silicone polyether, and a combination thereof, and wherein the pH control agent is selected from the group comprising Auxigreen acid, citric acid, acetic acid and combinations thereof

10. The graphene-based dispersion as claimed in claim 8, wherein the graphene-based dispersion comprises the wetting agent(s) at a concentration ranging from about 0.1% to about 1% (w/w); the lubricating agent(s) at a concentration ranging from about 0.01% to about 1% (w/w); the defoaming agent(s) at a concentration ranging from about 0.10% to about 2% (w/w); the pH control agent(s) at a concentration ranging from about 0.10% to about 10% (w/w); and/or

11. The graphene-based dispersion as claimed in claim 1, wherein stability of the graphene-based dispersion ranges from about 1 month to about 2 years.

12. A method of preparing the graphene-based dispersion as claimed in claim 1, comprising dispersing graphene and/or its derivatives in a liquid medium and subjecting said dispersion to mixing in a high shear mixer, to obtain the graphene-based dispersion.

13. The method as claimed in claim 12, comprising dispersing graphene and/or its derivatives along with one or more of surfactant(s), wetting agent(s), lubricating agent(s), defoaming agent(s), pH control agent(s) in a liquid medium and subjecting the dispersion to mixing in a high shear mixer, to obtain the graphene-based dispersion.

14. The method as claimed in claim 12, wherein speed of mixing the dispersion in the high shear mixer ranges from about 100 rpm to about 10000 rpm; and wherein the mixing of the dispersion in the high shear mixer is performed for about 1 minute to about 600 minutes

15. A substrate comprising the graphene-based dispersion the graphene-based dispersion as claimed in claim 1; wherein the substrate is selected from conductive and non-conductive material or a combination thereof.

16. A method of preparing the substrate as claimed in claim 15, comprising applying the graphene-based dispersion to the substrate by a method selected from a group comprising dipping, coating, dyeing, brushing, painting, spraying and printing to obtain the substrate comprising the graphene-based dispersion.
